(19) United States
(12) Patent Application Publication
(10) Pub. No.: US 2011/0278250 A1
(43) Pub. Date: Nov. 17, 2011

(54) Anti-Vibration Rack With Anti-Vibration Module

(76) Inventor: Mohammad Ghassem Malekmadani, Palo Alto, CA (US)

(21) Appl. No.: 13/082,356

(22) Filed: Apr. 7, 2011

Related U.S. Application Data
(63) Continuation-in-part of application No. 12/476,239, filed on Jun. 1, 2009.
Application No. 12/476,239 is a continuation-in-part of application No. 11/653,414, filed on Jan. 11, 2007.
(60) Provisional application No. 61/321,529, filed on Apr. 7, 2010.
(60) Provisional application No. 60/761,219, filed on Jan. 11, 2006.

(51) Int. Cl. F16F 7/00; A47F 7/00; A47B 96/06; A47F 5/00

(52) U.S. Cl. 211/134; 211/183

(57) ABSTRACT

A novel apparatus and system for damping vibrational forces from servers and electronic components is provided. Embodiments of the present invention generally provide novel anti-vibration modules adapted for use in existing racks as well as novel anti-vibration racks comprised of composite materials, which reduce the effect of vibration and noise on the components it stores.

### CROSS-REFERENCE TO RELATED APPLICATIONS

This application claims priority from U.S. Provisional Patent Application Ser. No. 61/321,529, filed Apr. 7, 2010, and is a continuation-in-part of prior U.S. patent application Ser. No. 12/476,239, filed Jun. 9, 2009, which is a continuation-in-part of U.S. patent application Ser. No. 11/653,414, filed Jan. 11, 2007, which claims priority from U.S. Provisional Patent Application Ser. No. 60/761,219, filed Jan. 11, 2006, all of which are incorporated herein by reference in their entirety for all purposes.

### FIELD OF THE INVENTION

The embodiments of the invention described herein relate generally to shelf and rack systems for servers and electronic components, and more particularly to apparatuses and methods for minimizing vibration from servers and electronic components.

### BACKGROUND

Data centers and server racks are extremely noisy places. The noise resulting from vibration can be significant. Multiple sources of vibration contribute to the vibration level of server racks in data centers, including but not limited to computer room air conditioners (CRACS) for building and racks; chillers; building, rack and server transformers; building/rack un-interruptible power supplies (UPS) and rack/server/hard disc drives (HDD); and cooling fans. These are all very noisy and collectively create a very complex and high level of vibration at wide ranges of frequency. Vibration levels at data centers, server racks and servers vary and typically can be 1 g or more.

Existing server racks are fabricated without vibration dissipating measures. Generally made from steel sheet metal, existing rack structures actually magnify vibration rather than mitigating it.

Hard disc drives are very sensitive to vibration. When looking for a file to read, the head is moving inward or outward as the disc is spinning in order to locate the beginning of the file. Vibration makes this task more difficult as the head searches for the file location on the disc. HDD manufacturers have implemented vibration sensors in the HDDs to sense vibration and to pause I/O operation in presence of high vibration. Input/Output (I/O) becomes much faster and more efficient as vibration is suppressed. Generally, write operations take longer than read operations and are more sensitive to vibration. Many server/computer operations are I/O—intensive workloads, e.g., on-line transaction processing (OLTP) applications, video streaming, web serving, and finance applications.

Vibration at wide ranges of frequencies interferes with HDD operation and in some cases causes the corresponding server or computer to shut down. As a result, there is a need for anti-vibration measures at various frequencies to dissipate vibration in servers thereby allowing HDDs to perform much more efficiently.

Vibration may interfere with the operation of HDDs, cooling fans and other server components resulting in reduction of performance and increase in energy consumption. Therefore there is a need for a means to minimize or eliminate vibration.

### SUMMARY

One embodiment of the present invention provides an apparatus for damping vibration from a server. The apparatus includes anti-vibration modules wherein the anti-vibration modules are configured to couple with a server slide rail kit in four corners to support a server.

Embodiments of the novel anti vibration rack described herein optimize structural stiffness and damping to mitigate vibration at all operating frequencies in servers and data centers. Embodiments of the present invention provide for a novel anti-vibration rack (AVR) that dissipates vibration at wide frequency ranges. For example, the novel AVR may dissipate vibration from 10 Hz to several thousand and perhaps in several hundred thousand Hz. The frequency range of interest in HDD operation is preferably from 50 Hz to 2,000 Hz. Testing of various embodiments of the novel server AVR verify the effect of its anti-vibration technologies on servers' performance and energy consumption. Embodiments of the novel AVR dissipate vibration passively, effectively eliminating vibration in all interested frequency ranges.

An embodiment of the present invention provides an apparatus for damping vibration from one or more electronic components such as a server, other servers housed in the same rack, a server rack fan, a power distribution unit, or adjacent server racks. The apparatus includes anti-vibration modules wherein the anti-vibration modules are preloaded by exerting a force on the anti-vibration modules assembly which is configured to couple a server slide rail kit to a server.

Other and further features and advantages of the present invention will be apparent from the following descriptions of the various embodiments. It will be understood by one of ordinary skill in the art that the following embodiments are provided for illustrative and exemplary purposes only, and that numerous combinations and modification of the elements of the various embodiments of the present invention are possible.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIGS. 1A-1B are a front and a perspective view respectively of an exemplar server rack system in accordance with an embodiment of the present invention;

FIGS. 2A-2B are an end view and a perspective view of an exemplar rack system in accordance with an embodiment of the present invention;

FIGS. 3A-3B are an end view and a perspective view of an anti-vibration mount in accordance with an embodiment of the present invention; and

FIGS. 4A-4B are a front view and a perspective view of another exemplar anti-vibration mount in accordance an embodiment of the present invention.

### DETAILED DESCRIPTION

The embodiments of the present invention are described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements.

Embodiments of the invention provide anti-vibration methods implemented in novel anti-vibration racks (AVR) that may be used in data and server centers and in existing server racks and servers. In various embodiments the AVRs are designed to dissipate vibration. Embodiments of the invention providing for anti-vibration measures implemented on existing racks include novel anti-vibration server mount attachments and novel anti-vibration mount assemblies and server feet support. Although the embodiments of the present invention are described in connection with servers, the embodiments are not so limited and are equally applicable to other electronic components or devices in which it is desirable to limit vibration or noise. In addition, the embodiments of the present invention may be used to limit vibration from other servers housed in the same rack as a server, a server rack fan, a power distribution unit, and adjacent server racks,

According to one embodiment, the anti-vibration mounts herein include general spring-dashpot modules to support either the server directly and attach to the server rack as mounts or to be used as server feet supporting the server on the rack shelf.

In one embodiment, the novel anti-vibration modules take a variety of forms including rubber-springs, air dashpots or any other variation of spring-dashpot offering proper stiffness and damping to dissipate vibration. The embodiments described herein include anti-vibration modules made from elastomer (rubber like material) and fiber re-enforced plastics. The elastomer may be polyurethane, and fiber re-enforced plastics may be carbon fiber/epoxy composites and fiberglass re-enforced plastics.

In one embodiment, the anti-vibration modules dissipate vibration in all operating frequency ranges passively or actively. Active vibration dissipation modules are comprised of vibration sensors to sense vibration force and frequency and then automatically or manually adjust its stiffness and damping to counter it. In embodiments including air dashpots, the air pressure is adjusted to accomplish this task. One example of an embodiment is a passive anti-vibration rack. The use of materials like polyurethane, carbon fiber and fiberglass in the novel design presented herein provide vibration dissipation in wide ranges of frequencies. While not explicitly shown in the embodiments, it is contemplated with in the scope of the embodiment of the present invention that air dashpots may be incorporated as an additional vibration dissipation means, complimentary vibration dissipation means or alternatively as an exclusive means.

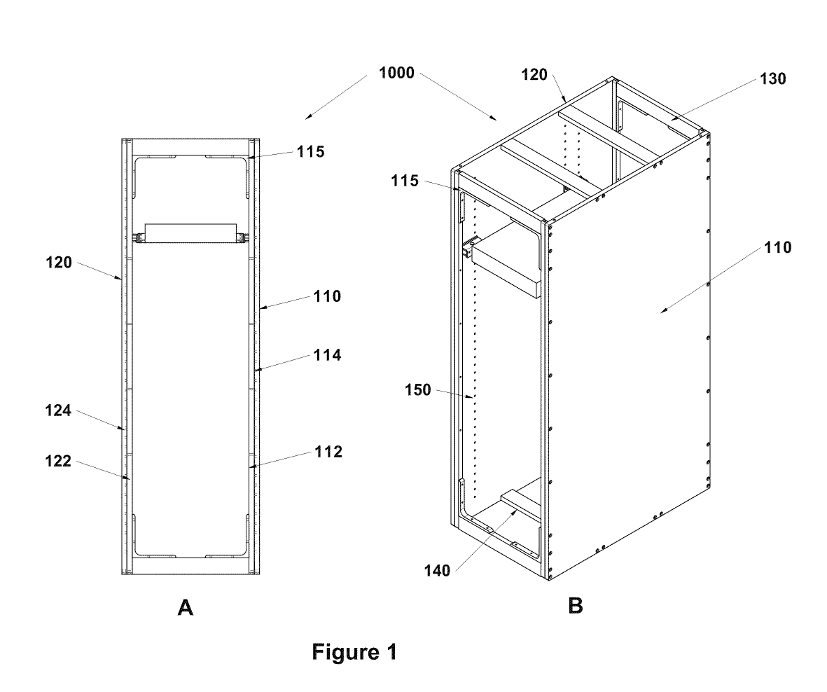

FIGS. 1A and 1B depict front and perspective views of an AVR 1000, according to one embodiment of the invention. The AVR 1000 may be designed and manufactured using aerospace structural and isolation principles. The AVR 1000 is constructed primarily from materials that assist in minimizing vibration and other interference. The selection of materials may influence the performance of a system. Materials that aid in minimizing vibration exist. An example of such is carbon fiber composites. Carbon fiber composites aid in minimizing vibration and are one of the optimal materials for these purposes. Various acrylics are also suitable for such purpose. In contrast, glass and metals are less desirable for damping and minimizing the effects of vibration, oscillation and the like.

Carbon fiber composite materials offer an excellent damping/stiffness combination. When a structure, like an AVR is designed properly, it dissipates vibration the most effectively as it utilizes stiffness, damping and mass. According to one embodiment of the invention, vibration dissipation may be maximized by selecting a material well suited for the purpose, such as a carbon fiber composite.

Carbon fiber generally refers to carbon filament thread, or to felt or woven cloth made from those carbon filaments. The term carbon fiber is also used to mean any composite material made with carbon filament, such a material is sometimes referred to as graphite-reinforced plastic.

Each carbon filament is made out of long, thin filaments of carbon sometimes transferred to graphite. A method of making carbon filaments is the oxidation and thermal pyrolysis of polyacrylonitrile (PAN), a polymer used in the creation of many synthetic materials. Like all polymers, polyacrylonitrile molecules are long chains, which are aligned in the process of drawing continuous filaments. When heated in the correct conditions, these chains bond side-to-side (ladder polymers), forming narrow graphene sheets which eventually merge to form a single, jelly roll-shaped or round filament. The result is usually 93-95% carbon. Lower-quality fiber can be manufactured using pitch or rayon as the precursor instead of PAN. The carbon can become further enhanced, as high modulus or high strength carbon, by heat treatment processes. Carbon heated in the range of 1500-2000° C. (carbonization) exhibits the highest tensile strength (820,000 psi or 5,650 MPa or 5,650 N/mm²), while carbon fiber heated from 2500 to 3000° C. (graphitizing) exhibits a higher modulus of elasticity (77,000,000 psi or 531 GPa or 531 kN/mm²).

There are several categories of carbon fibers: standard modulus (250 GPa), intermediate modulus (300 GPa), and high modulus (>300 GPa). The tensile strength of different yarn types varies between 2000 and 7000 MPa. The density of carbon fiber is 1750 kg/m3.

Precursors for carbon fibers are PAN, rayon and pitch. Rayon is used for certain specialized applications such as rockets and specific aerospace applications.

Carbon fiber filament yarns are used in several processing techniques, including prepregging, filament winding, pultrusion, weaving, braiding and the like. The filaments are stranded into a yarn. Carbon fiber yarn is rated by the linear density (weight per unit length=1 g/1000 m=tex) or by number of filaments per yarn count, in thousands. For example 200 tex for 3,000 filaments of carbon fiber is 3 times as strong as 1,000 carbon fibers, but is also 3 times as heavy. This thread can then be used to weave a carbon fiber filament fabric or cloth. The appearance of this fabric generally depends on the linear density of the yarn and the weave chosen. Carbon fiber is naturally a glossy black but colored carbon fiber is also available.

Carbon fiber may be used to reinforce composite materials, particularly the class of materials known as carbon fiber reinforced plastics. This class of materials is often used in demanding mechanical applications. Carbon fiber's unique properties such as high stiffness, high strength, high damping, low density, and corrosion resistance are ideal for demanding applications. Carbon fiber/epoxy composites have mechanical properties such as the stiffness and strength of steel, and damping of 10 times more than aluminum at 30% lower density.

While non-polymer materials can also be used as the matrix for carbon fibers, due to the formation of metal carbides (i.e., water-soluble AIC), bad wetting by some metals, and corrosion considerations, carbon is used less frequently in metal matrix composite applications.

With reference to FIG. 1, the AVR 1000 has a first side panel 110 and a second side panel 120. The AVR 1000 also has upper cross bars 130 and lower crossbars 140. The upper cross bars 130 and lower cross bars 140 may provide additional structural support. Alternatively, the upper cross bars 130 and lower cross bars 140 may merely act as a means to support the first side panel 110 and the second side panel 120. Although depicted with two upper cross bars 130 and two lower cross bars 140, the number of cross bars is not intended to be a limitation and there could be a greater or lesser number. Further, in alternate embodiments, there maybe no cross bars at all, or a solid or meshed surface creating and upper and a lower panel. The first side panel 110, second side panel 120, upper cross bars 130 and lower cross bars 140 form a box-like structure having an open face 150. The upper cross bars 130, lower cross bars 140 and side panels 110, 120 may be constructed from materials as described above. In another embodiment, some or all of the panels may be constructed from alternative materials. For example in one embodiment, some or all of the panels are plastic or plastic plate with or without fiberglass or carbon fiber reinforcement. In another embodiment, some or all of the panels are plastic with foam cores. In embodiments including foam cores, the panels may be molded with internal foam cores that are injected or comprised from sheets of foam. Alternatively, in embodiments including foam cores, the panels may be constructed as laminate layer with foam between the layers throughout or at the median of the layers. In another embodiment, the upper cross bars 130, lower cross bars 140 and side panels 110, 120 may be constructed from metal or metallic materials. Preferably the upper cross bars 130, lower cross bars 140 and side panels 110, 120 are ⅛″ to 1″ thick. However, in some instances it may be preferable to have thicker panels for example because of the strength needed to support the weight of the components contained in the cabinet. The AVR 1000 may be prefabricated as a unit or may be constructed such that it may be assembled.

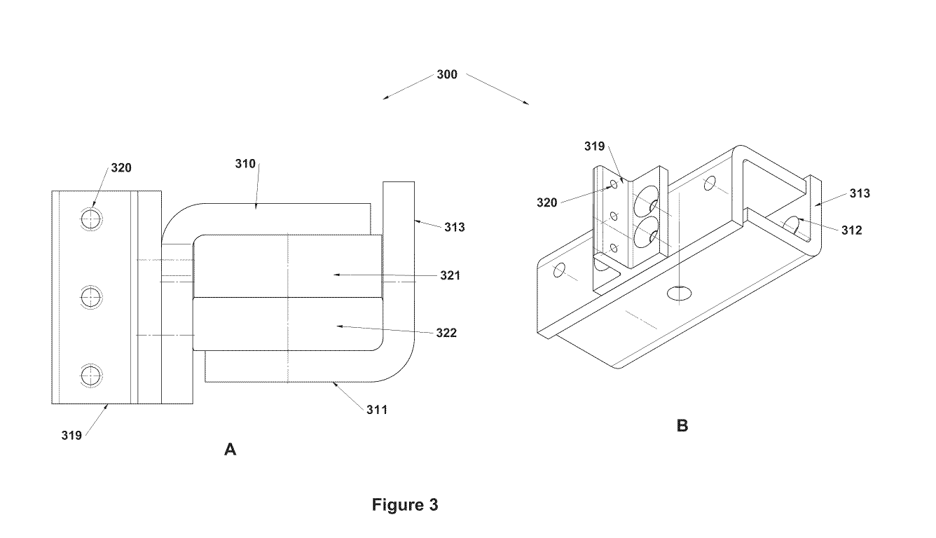

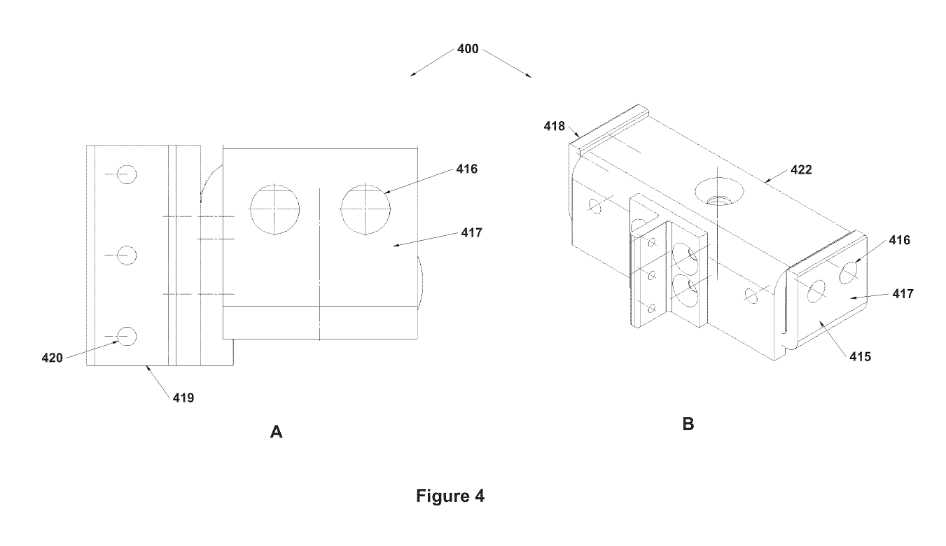

The first side panel 110 and the second side panel 120 each have an inner surface 112, 122 and an outer surface 114, 124. The outer surface 114,124 may be textured or smooth; the inner surface 112,122 may be configured with series of thread openings to which an anti-vibration module (AVM) may be coupled. Alternatively the openings may allow for pin fittings, to which an AVM may be coupled, or any other coupling means. In some embodiments, the AVM is one such as that described in conjunction with FIGS. 3-4 below. The AVM accepts and supports servers or other electronic equipment. Although depicted as a box like structure, this is not intended to be a limitation on the present invention. In one embodiment, an open shelving style system is constructed; in addition, in one embodiment, within a box like structure, additional side panels are installed so that multiple sub-boxes exist within a larger box. In one embodiment, an AVM is coupled at the inner or outer corners of the box like cabinet structure such that it creates a mounting brackets for a server slide rail assembly.

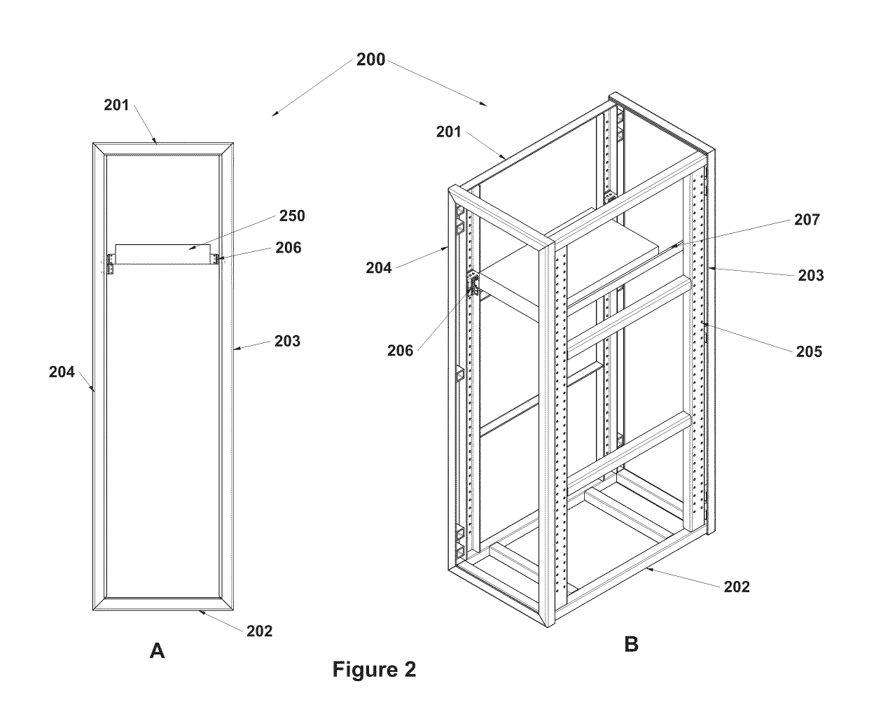

FIGS. 2A and 2B are a front view and a perspective view of an AVR 200 according to an embodiment of the present invention. The AVR 200 described herein is designed to dissipate vibration passively in various frequencies, which interfere with operation of HDDs, cooling fans and other server components. The AVR 200 consists of a rack cabinet similar to that described in conjunction with FIG. 1. In some embodiments, the AVR 200 is constructed in various sizes and configuration so that the shelves and/or server mounts are capable of supporting various size servers. The configuration shown herein is not intended to be a limitation on the embodiments of the present invention. AVR 200 also referred to herein as a rack cabinet, consists of four sections: two side panels 203 and 204, an upper panel 201 and a lower panel 202. The side panels 201 and 202 have coupling openings 205 to accept anti-vibration modules or other coupling systems for anti-vibration modules. In some embodiments, other attachment systems used include but are not limited to pins, hooks, ball bearing systems, peg systems, and fixed shelves. In some embodiments, the AVR 200 is constructed with structural bars of various cross sections, including but not limited to “L” angle, square cross section and “U” channels. In one embodiment, the preferred material for the angle bars is a fiberglass composites, but other composites or plastics or metals may be implemented to construct the AVR 200.

In an embodiment shown in FIG. 2, a server 250 is coupled to its own metal slide rail assembly 207 which may be coupled to an anti-vibration module 206. In this configuration the server can then be slid in and out of the AVR. In one embodiment, the slide rail assembly 207 is a conventional slide rail assembly as available such that the novel AVR is adapted for use without significant modification to existing components. In an embodiment, the anti-vibration module 206 is constructed from variety of materials. For example, carbon fiber composite or fiberglass composite materials offer an excellent damping/stiffness combination.

The stiffness and damping properties of materials and structures vary with operational frequencies. The relationship between an arbitrary vibration force F and the resulting motion X of a multiple degree of freedom structure can be presented as:

MX″+CX′+KX=F

where X is displacement (motion), X′ velocity, X″ is acceleration, M represents mass, C damping and K stiffness of the structure.

In one embodiment, the preferred method of fabrication of an AVR cabinet 200 is molded fiberglass, chopped carbon fiber or other re-enforced plastics. In another embodiment, the AVR 1000 frame is machined from sheet stock of plastics like Acrylic or polycarbonate. In another embodiment, the AVR cabinet 200 may be constructed from other materials, which aid in vibration dissipation and methods to control costs.

FIGS. 3A-3B depict an anti-vibration module (AVM) 300 according to one embodiment of the invention. The AVM 300 is generally constructed from “L” shaped brackets. However, this cross section is not intended to be a limitation on the embodiments of the present invention and other cross sections may be implemented without departing from the spirit and scope of the embodiments of the present invention. The anti-vibration module 300 further comprises a top bracket 310, and two component modules to reduce vibration. In one embodiment, a component module comprises one of elastomer 322, (e.g., polyurethane and Sorbothane), and a component module comprises one of advanced fiber composite 321 (e.g., carbon fiber, or other fiber with resin), which are attached or coupled by fasteners, or other mechanical means, to a bottom bracket 311. In one embodiment, the modules are rings, circles, squares or any other geometric shape as may be accommodated by the bracket. The bottom bracket 311 is of such a thickness that it is sufficient to support the weight of the server or other electronic component. Preferably, the bottom bracket 311 may be 0.1″ to 1″ inch thick. The bottom bracket 311 as depicted has an “L” shape cross section and has an opening 312 on its vertical side 313 for attaching or coupling by a bolt or other means to an AVR frame. In one embodiment, the bottom bracket 311 is approximately 0.25″ thick. The bottom bracket 311 may be constructed from carbon fiber or fiberglass or any other suitable material. Fiberglass may be preferably used for its cost saving advantages. In an embodiment, the thickness of the upper bracket is 0.20″-0.30″.

As shown, the AVM 300 optionally includes a “T” bracket 319. In one embodiment, a server slide rail may be coupled to the “T” bracket 319 by a screw or other coupling means at the openings 320.

FIGS. 4A-4B show anti-vibration module (AVM) 400 according to one embodiment of the invention. The AVM 400 is generally constructed from “U” shaped brackets. However, this cross section is not intended to be a limitation on the embodiments of the present invention and other cross sections may be implemented without departing from the scope or spirit of the embodiments of the present invention. AVM 400 includes a bottom bracket, which is constructed from a “U” channel material. FIG. 4 depicts a U-channel bottom bracket 415. The anti-vibration module 400 further comprises a top bracket 422, and two modules to reduce vibration. In one embodiment, one such module to reduce vibration is one of polyurethane (e.g., sorbothane), and another such module to reduce vibration is one of carbon fiber, which are attached or coupled by fasteners, or other mechanical means, to the bottom bracket 415, according to the embodiment. In an embodiment, the modules may be rings, circles, squares or any other geometric shape as may be accommodated by the bracket. The bottom bracket 415 includes coupling opening 416 on vertical sides 417 and 418. The U shaped bracket may be constructed as a single piece or from multiple pieces such that the vertical sides 417, 418 are distinct pieces. In this embodiment, the anti-vibration module 400 may be coupled to two vertical posts of an AVR frame.

As shown, the AVM 400 optionally includes a “T” bracket for coupling the AVM to an AVR. The server slide rail couples to the “T” bracket 419 by screw or other coupling means at openings 420.

In one embodiment, the anti-vibration module system comprises at least four mounts, i.e., AVM 300, more preferably, two mounts 300 are located on either side of the server such that the server slid rail assembly couples to mounts 300 on its ends and are able to support the server 250.

In one embodiment, front and back doors are provided to create an enclosure for the cabinet 300. In such a configuration, the doors attach to the side panels via hinges and latches or other mechanical means. The doors may be solid, with meshed opening allowing for air circulation, or other venting means.

In one embodiment, the structural members of the AVR 200 as shown in FIG. 2 are covered on the exterior sides with a skin. In the embodiment, the skin is composed of plastic or any other nonporous material. The skin prevents side to side air flow through the structural members, and also aids in ensure the security and safety of the servers that may be stored in the AVR 200. In one embodiment, an anti-vibration rack includes front, back, top and bottom panels. In one embodiment, the front and back panels are doors are constructed from solid non-porous materials with venting incorporated in the material. In one embodiment, the material may be a mesh, a plastic panel with venting openings to allow for air circulation. The top and bottom panels may be similarly constructed with or without venting.

In one embodiment, in use, each server or other component is supported in the AVR 200 by two AVMs 300 on each side.

An additional novel safety feature of embodiments of the present invention is that if there is too much load when a heavy server is pulled out of the AVR 200, i.e., the server slide rail is extended from the front of the rack, the AVM top bracket 310 directly contacts the AVM bottom bracket 311 and therefore transfers the server load to the bottom bracket 311 instead of the anti-vibration modules, which may be fully compressed. This configuration provides more support than a server slide rail provides on its own.

In another embodiment the upper bracket and the carbon fiber component of anti-vibration module are combined together. In this embodiment, the upper bracket comprises carbon fiber or fiber glass re-enforced plastics. In another embodiment, the upper bracket comprises neat (no re-enforcement) plastics. The carbon fiber or fiberglass re-enforced plastic may be made by pulltrusion, lamination, chopped fiber molding or other techniques. In this embodiment polyurethane elastomer is implemented in its preferred compressed state.

Embodiments of the present invention also include methods for reducing vibration of a component in a rack having a support means on either side of the rack inner side panels. The method includes positioning the component on a carbon fiber shelf having at least two opposite sides; attaching at least one compression block to each of the at least two opposite sides of the carbon fiber shelf; and placing the carbon fiber shelf with the component on the carbon fiber shelf in the rack such that each of the at least one compression block mates with the support means located on either side of the rack.

As noted previously the forgoing descriptions of the specific embodiments are presented for purposes of illustration and description. They are not intended to be exhaustive or to limit the invention to the precise forms disclosed and obviously many modifications and variations are possible in view of the above teachings. The embodiments were chosen and described in order to explain the principles of the invention and its practical applications, to thereby enable those skilled in the art to best utilize various embodiments of the invention as suited to the particular use contemplated. It is intended that the scope of the invention be defined by the claims and their equivalents.

What is claimed is:

1. An apparatus for damping vibration comprising:
an upper support;
a lower support;
at least one side panel positioned between the upper support and lower support, the side panel having one of more coupling openings along the inner height of the side panel; and
at least one anti-vibration module coupled to an inner surface of the side panel through at least one of the multiple coupling openings.

2. The apparatus of claim 1, further comprising at least one slide rail assembly coupled to the anti-vibration module.

3. The apparatus of claim 1, wherein the side panel is constructed with a foam core.

4. The apparatus of claim 1, wherein the anti-vibration module comprises at least two damping component modules.

5. The apparatus of claim 4, wherein a first damping module is composed of a material that is distinct from a second damping module.

6. The apparatus of claim 4, wherein a first damping module is composed of an elastomer, and a second damping module is composed of a fiber composite.

7. The apparatus of claim 4, wherein a first damping module is composed of polyurethane, and a second damping module is composed of carbon fiber.

8. The apparatus of claim 1, wherein the anti-vibration module is preloaded with an exerted force.

9. The apparatus of claim 1, wherein the upper support, the lower support and the side panel are comprised of fiber re-enforced plastics.

10. An apparatus for damping vibration in a server rack comprising:
at least one anti-vibration module coupled to an inner surface the server rack; and
at least one slide rail assembly coupled to the anti-vibration module.

11. The apparatus of claim 10, wherein the anti-vibration module comprises at least two damping component modules.

12. The apparatus of claim 11, wherein a first damping module is composed of a material that is distinct from a second damping module.

13. The apparatus of claim 11, wherein a first damping module is composed of an elastomer, and a second damping module is composed of a fiber composite.

14. The apparatus of claim 11, wherein a first damping module is composed of polyurethane, and a second damping module is composed of carbon fiber.

15. The apparatus of claim 10, wherein the anti-vibration module is preloaded with an exerted force.

16. A method for reducing vibration of components in a rack, the method comprising:
preloading at least one anti-vibration module with an exerted force;
coupling the anti-vibration module to a side of at least one component;
supporting the at least one component in the rack.

17. The method of claim 16, wherein supporting the at least one component in the rack comprises coupling the at least one component to a server slide assembly.

18. An apparatus for damping vibration comprising:
an upper support;
a lower support;
at least one side panel positioned between the upper support and lower support, the side panel having one of more coupling openings along the inner height of the side panel, wherein the side panel is constructed with a foam core;
at least one anti-vibration module coupled to an inner surface of the side panel through at least one of the multiple coupling openings, wherein the anti-vibration module is preloaded with an exerted force, wherein the anti-vibration module comprises at least two damping component modules, wherein a first damping module is composed of an elastomer, and wherein a second damping module is composed of a fiber composite;
at least one slide rail assembly coupled to the anti-vibration module, wherein the upper support, the lower support and the side panel are comprised of fiber re-enforced plastics.
